(19) United States
(12) Patent Application Publication
(10) Pub. No.: US 2008/0258867 A1
(43) Pub. Date: Oct. 23, 2008

(54) Recreational vehicle wireless keyless power door lock

(75) Inventors: Cade Harris, Hyrum, UT (US); Jeff Brown, NorthLogan, UT (US)

Correspondence Address: THORPE NORTH & WESTERN, LLP., P.O. Box 1219, SANDY, UT, 84091-1219, US

(73) Assignee: Cade Harris

(21) Appl. No.: 11/787,921

(22) Filed: Apr. 17, 2007

(51) Int. Cl. G05B 19/00

(52) U.S. Cl. 340/5.64; 280/5.2; 70/256

(57) ABSTRACT

A power door lock device for a walkthrough door of a Recreational Vehicle (RV) includes a lock disposed in a lock housing. The power door lock also includes an actuator operably coupled to the lock and operable to engage the lock. A wireless receiver is coupled to the actuator and is configured to receive a wireless signal to operate the actuator. A remote wireless transmitter is configured to transmit a signal to the wireless receiver in order to actuate the lock.

### BACKGROUND

Recreational vehicles (RV), such as motor homes, camp trailers, travel trailers, tent trailers and the like, typically have walkthrough doors that a standing person can walk through in order to enter or leave the RV. These doors generally have a lock that can secure and lock the door in a closed position in order to restrict access to the interior of the RV. Such RV walkthrough door locks are usually manually activated by the user either by turning a door handle, or disengaging a locking member when standing next to the door. Similarly, locked doors can be unlocked with a key that the user can insert into the lock while standing next to the door.

Unfortunately, both locking and unlocking the RV door lock require the user to be standing within reach of the door. This can be inconvenient to the user who desires to lock or unlock the RV door but is located some distance away from the RV. For example, in the case of a camp trailer that is pulled behind a passenger vehicle, a user may wish to lock or unlock the door while remaining in the passenger vehicle, but the user would be unable to activate the lock from this distance.

### SUMMARY

The present invention provides a power door lock device for a walkthrough door of a Recreational Vehicle (RV) including a lock disposed in a lock housing. The power door lock also includes an actuator operably coupled to the lock and operable to engage the lock. A wireless receiver can be coupled to the actuator and can receive a wireless signal to operate the actuator. A remote wireless transmitter can be configured to transmit a signal to the wireless receiver in order to actuate the lock.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a perspective view of a Recreational Vehicle (RV) with a wireless power door lock including a wireless remote in accordance with an embodiment of the present invention;

FIG. 2 is a fragmentary side view of the RV of the embodiment shown in FIG. 1, showing a walkthrough door with a wireless power door lock;

FIG. 3 is a perspective front view of a wireless power door lock in accordance with an embodiment of the present invention;

FIG. 4 is a partially exploded perspective view of the wireless power door lock of the embodiment shown in FIG. 3;

FIG. 5 is a perspective back view of the wireless power door lock of the embodiment shown in FIG. 3;

FIG. 6 is a partially exploded perspective view of the wireless power door lock of the embodiment shown in FIG. 3;

FIG. 7 is an exploded perspective view of a lock including a dead bolt of the wireless power door lock of the embodiment shown in FIG. 3;

FIG. 8 is a perspective back view of lock housing of the wireless power door lock of the embodiment shown in FIG. 3;

FIG. 9 is a perspective exploded view of an actuator of the wireless power door lock of the embodiment shown in FIG. 3;

FIG. 10a is a perspective view of a lock rod of the actuator of the embodiment shown in FIG. 8, shown with a clutch attached;

FIG. 10b is another perspective view of the lock rod and clutch of the embodiment shown in FIG. 10a;

FIG. 10c is a perspective view of a lock rod of the actuator of the embodiment shown in FIG. 8, shown with another embodiment of a clutch attached;

FIG. 10d is another perspective view of the lock rod and clutch of the embodiment shown in FIG. 10c;

FIG. 11 is an exploded perspective view of the lock rod and clutch of the embodiment shown in FIGS. 10a and 10b;

FIG. 12 is an exploded perspective view of a battery power source of the wireless power door lock of the embodiment shown in FIG. 3;

FIG. 13a is a perspective view of a battery cover of the wireless power door lock of the embodiment shown in FIG. 3 shown with an emergency battery hook up;

FIG. 13b is another perspective view of a battery cover of the wireless power door lock of the embodiment shown in FIG. 3 shown with an emergency battery hook up;

FIG. 13c is a perspective view of a battery cover in accordance with another embodiment of the wireless power door lock of FIG. 3, shown with an emergency battery hook up;

FIG. 14 is a perspective view of the wireless power door lock of FIG. 3 shown with the emergency battery hook up of the embodiment shown in FIGS. 13a and 13b; and

FIG. 15 is a perspective view of the wireless power door lock of FIG. 3 shown with the emergency battery hook up of the embodiment shown in FIGS. 13a and 13b.

### DETAILED DESCRIPTION OF EXEMPLARY EMBODIMENT(S)

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention. The following detailed description and exemplary embodiments of the invention will be best understood by reference to the accompanying drawings, wherein the elements and features of the invention are designated by numerals throughout.

The present invention is generally directed to a power door lock for a walkthrough door of a Recreational Vehicle (RV). The power door lock can be actuated with a wireless transmitter in order to lock or unlock the door lock from a remote location with respect to the walkthrough door. The wireless transmitter can be in the form of a remote control, key FOB, or the like and can transmit a wireless signal such as an RF signal, an ultrasonic signal, an infrared signal, or the like. The power door lock can have a wireless transceiver that can receive the wireless signal from the transmitter.

An actuator, such as an electric motor, can be activated upon receipt of the wireless signal by the transceiver in order to turn a worm gear. The worm gear can be coupled to a screw gear on a clutch. The screw gear can rotate to engage a pin on the clutch. With the pin engaged, the clutch can turn a cam that can push a dead bolt from the power door lock and into an adjacent door jam to lock the door. The door can be unlocked by sending a wireless signal to the receiver to actuate the worm gear and rotate the screw gear, thereby turning the cam to retract the dead bolt out of the adjacent door jam and into the power lock. Additionally, the pin can be disengaged by a manual force on the door handle on the inside of the RV in order to disengage the clutch, and allow the walkthrough door to be opened. The power door lock can be a discreet modular unit, including a battery power source that can be sized and shaped to fit within the door lock space of an existing RV walkthrough door so that the power door lock can easily be retrofitted into walkthrough doors of existing RVs.

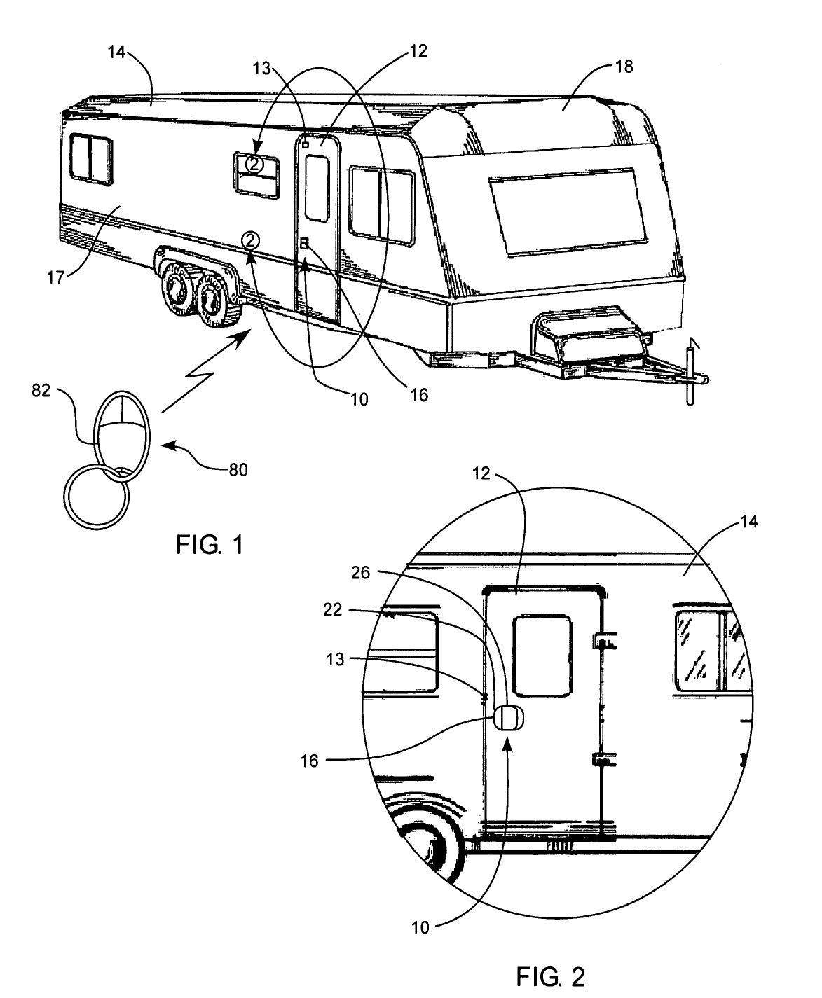

As illustrated in FIGS. 1-6, a power door lock device, indicated generally at 10, is shown in accordance with an embodiment of the present invention, for use with a walkthrough door 12 of a Recreational Vehicle (RV) device 14. The power door lock 10 includes a lock housing, indicated generally at 20, a lock 42, an actuator, indicated generally at 40, a wireless receiver 70, and a wireless transmitter, indicated generally at 80.

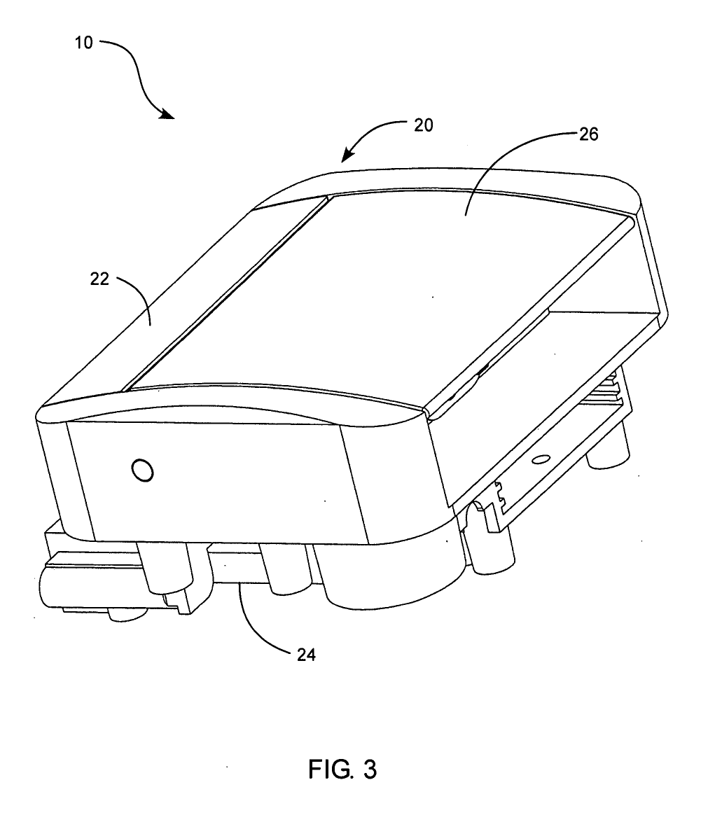

Referring to FIGS. 1-2, the lock housing 20 can be sized and shaped to fit within the door lock space 16 of a walkthrough door 12 on an RV 14, such as a travel trailer 18, camp trailer, motor home, tent trailer, fifth wheel trailer, van, bus, and the like. For purposes of this application, a walkthrough door 12 is a door having sufficient height and width to allow a person of average height to walk through the door frame 13 in a generally upright manner. As such a walkthrough door can be a cargo door, a personnel door, or the like, although in this application these doors will herein be referred to as walkthrough doors. Walkthrough doors 12 are typically installed in an outer shell 17 of the RV 14.

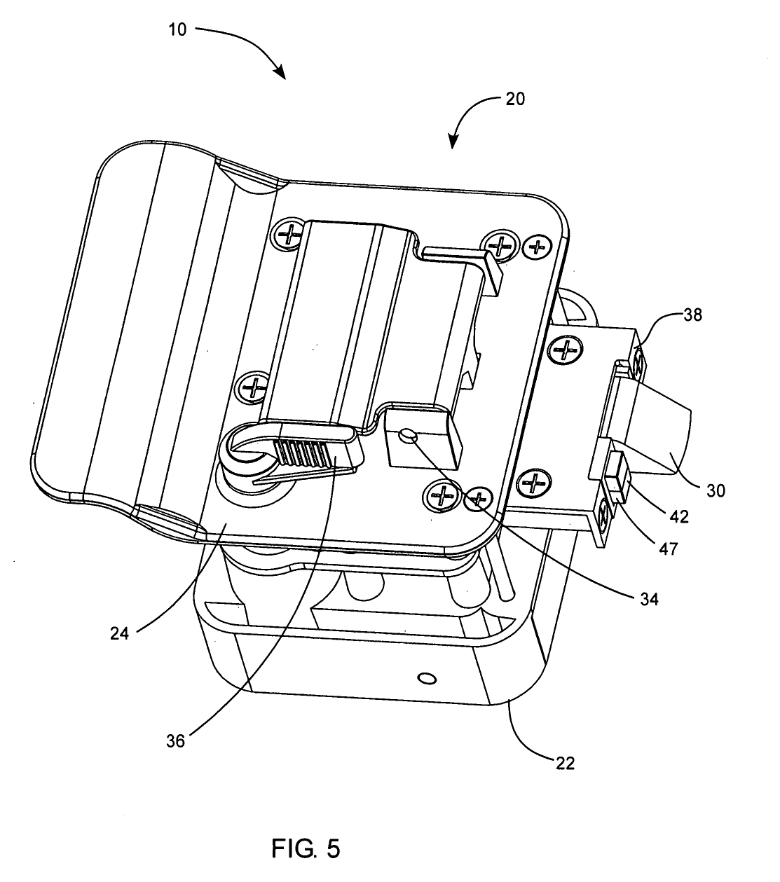

The lock housing 20 can have an outside plate 22, configured to be located on the outside of the RV 14 when the power lock 10 is disposed in the door lock space 16. The lock housing 20 can also have an inside plate 24 (FIG. 5) configured to be located on the inside of the RV 14 when the power lock 10 is disposed in the door lock space 16. Advantageously, the lock housing 20 can be sized and shaped so that the power door lock 10 can be easily retrofitted into walkthrough doors of existing RVs.

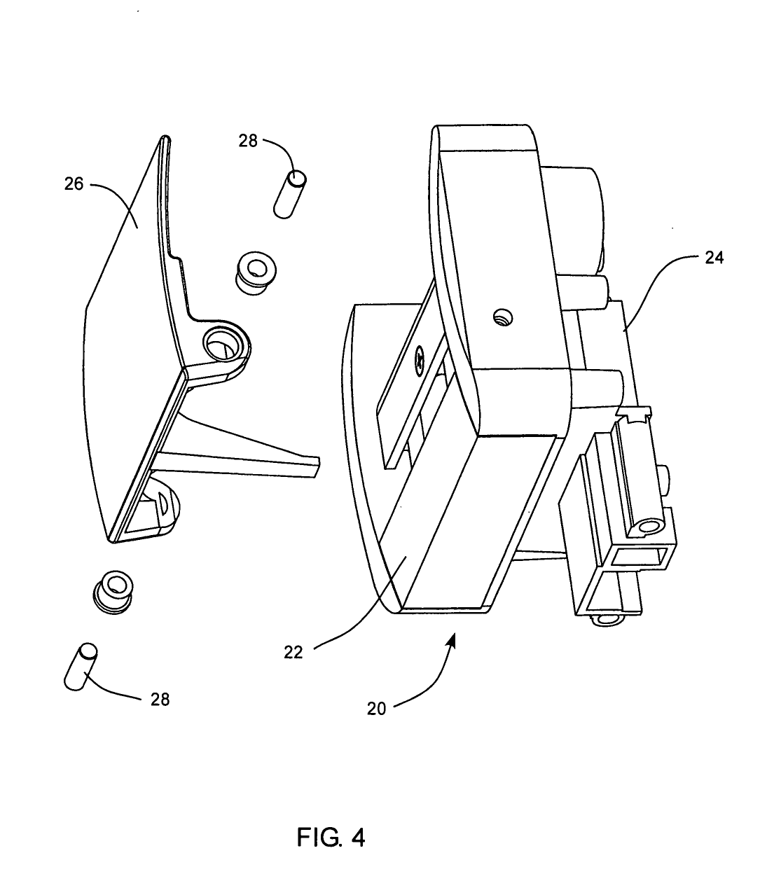

Referring to FIGS. 3-4, the outside plate 22 can also include an outside handle 26. The outside handle 26 can be pivotally coupled to the lock housing 22. The outside handle 26 can pivot about pivot pins 28 between a closed position and an open position. In the open position, the outside handle 26 is pivoted away from the outside plate 22 of the lock housing 20. Pivoting the outside handle 26 to the open position can retract a hasp 30 in the power door lock 10.

Referring to FIG. 5-7, the hasp 30 is normally in an extended position extending away from a side 38 of the lock housing 20. The hasp 30 can be biased by a biasing device such as a spring 31 to the extended position. An upper cover plate 45 can enclose the actuator 40, the hasp 30, and the spring 31 in the lock housing 20.

In the extended position, the hasp 30 can extend into the door frame of the RV to secure the walkthrough door 12 to the adjacent door frame. When the outside handle 26 (FIG. 3) is moved to the open position, the hasp 30 is retracted into the lock housing 20 so that the walkthrough door 12 can be manually released from the RV frame when the lock 42 is not engaged.

Similarly, the inside plate 24 can include an inside handle 32. The inside handle 32 can also be pivoted about pivot pins 34 between an open and closed position and coupled to the hasp 30 such that the hasp 30 is retracted into the lock housing 20 when the inside handle 32 is in the open position. In this way, the power door device lock 10 can be manually opened from either inside or outside the RV.

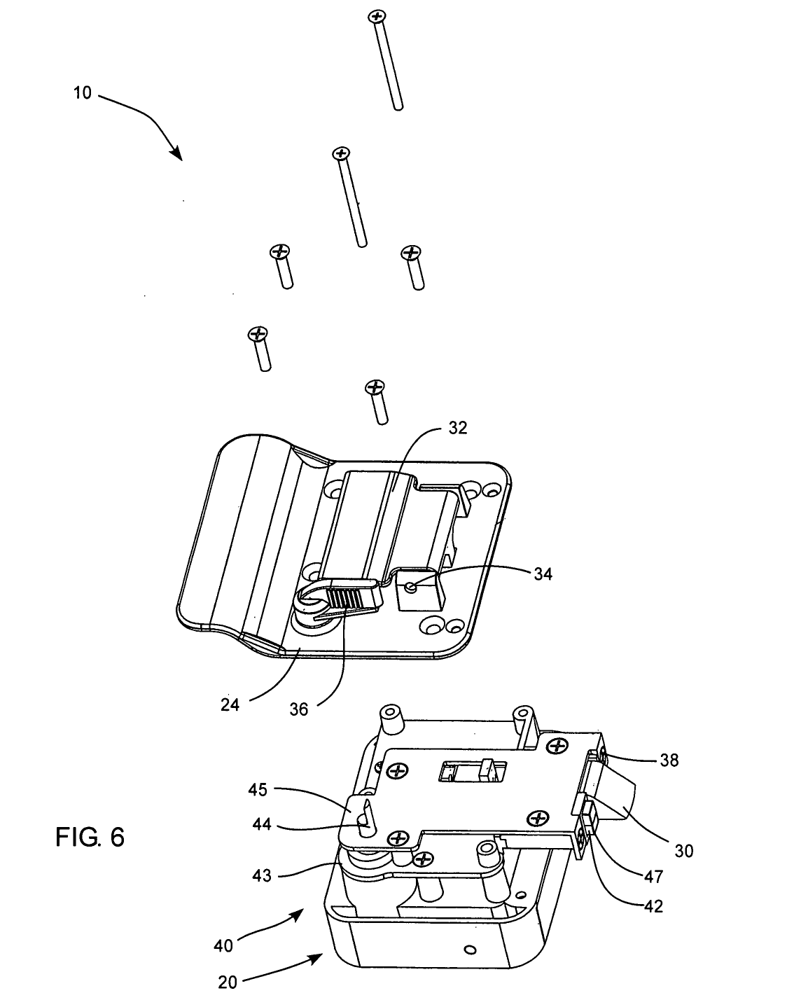

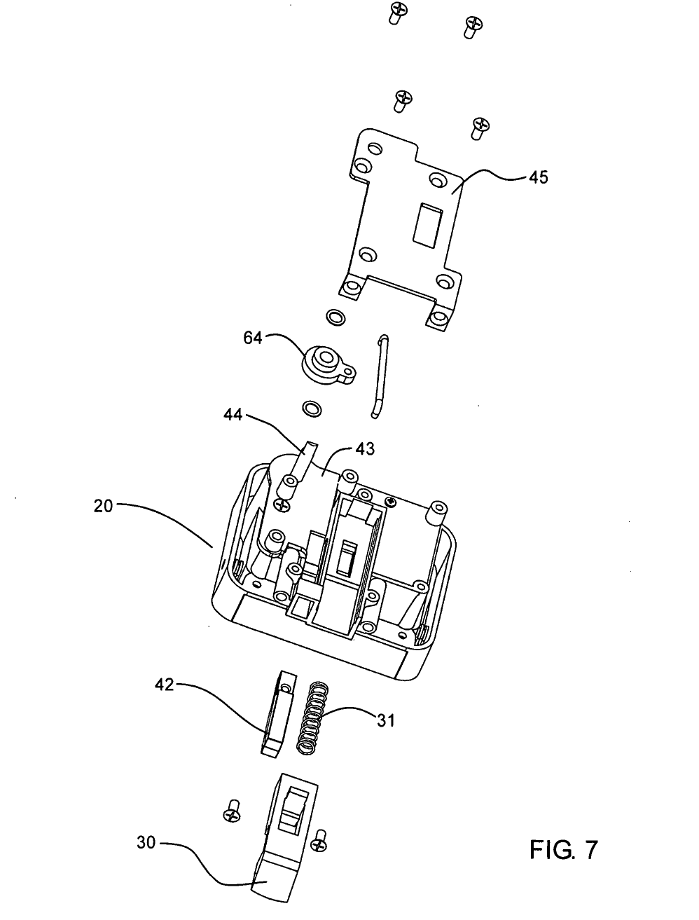

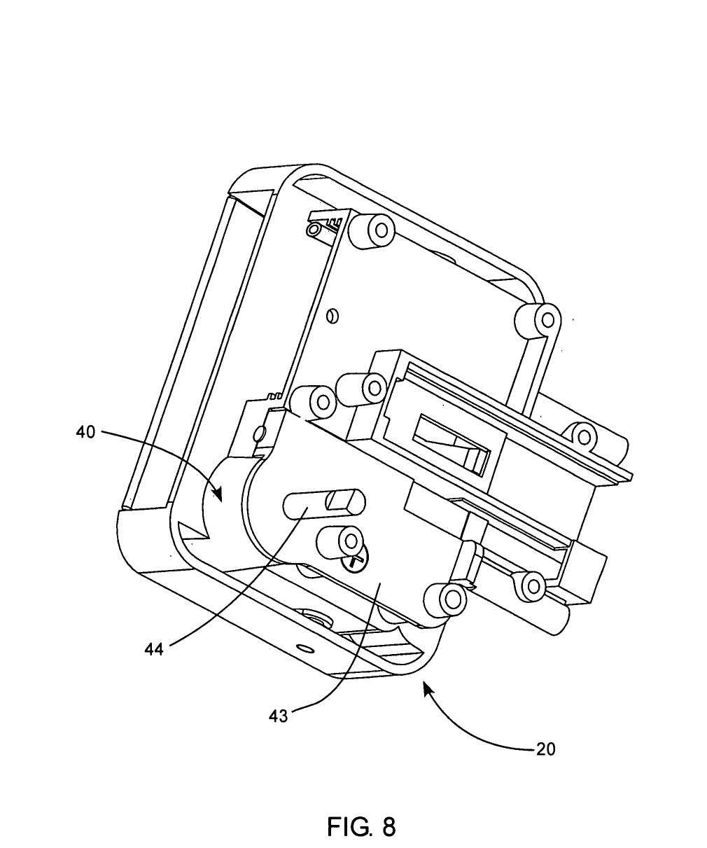

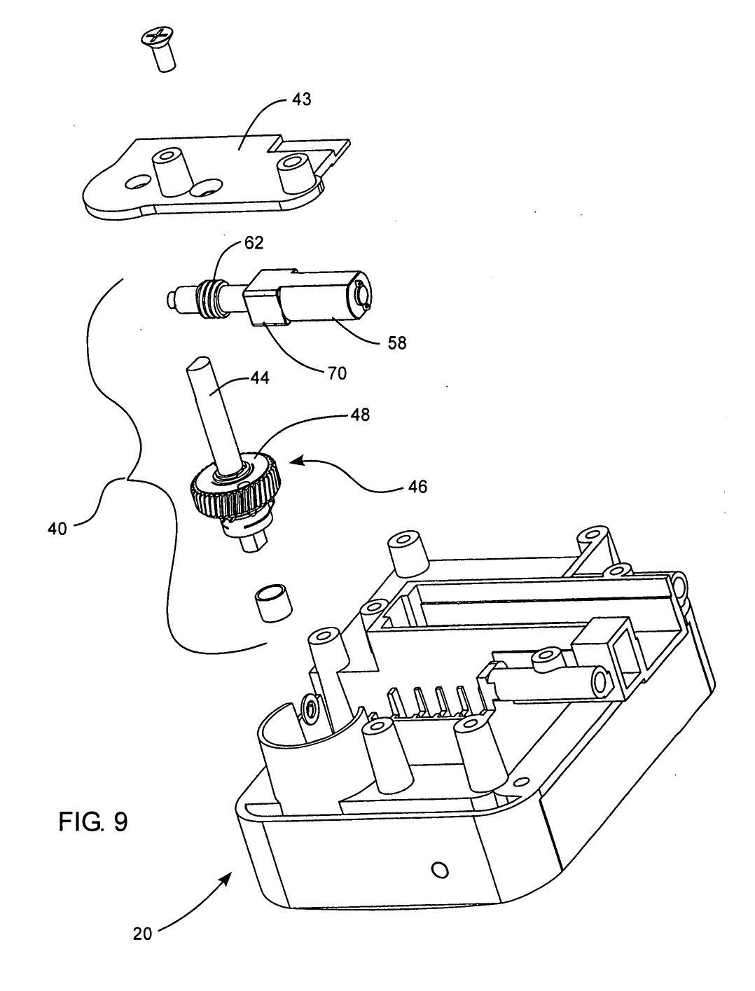

Referring to FIGS. 8-9, the lock housing 20 can also enclose the actuator, indicated generally at 40. The actuator 40 can be disposed under the inside plate 24, as shown in FIG. 6, and the upper cover plate 45, as shown in FIG. 7. Additionally, a lower cover plate 43 can also be removed to allow removal of the actuator, as shown in FIG. 9. The actuator 40 can include an electrically powered driver 58, a lock rod 44, and a clutch, indicated generally at 46.

Returning to FIGS. 6-7, the actuator 40 can be operably coupled to the lock housing 20 and can operate to engage a lock 47, such as a dead bolt 42. The actuator 40 can move the dead bolt 42 between a locked and an unlocked position. Specifically, the lock rod 44 can rotate a cam 64 that can move the dead bolt 42 between the locked and unlocked position. In the locked position, the dead bolt 42 can extend from the lock housing 20 into the door frame of the RV. In the unlocked position the dead bolt 42 can be retracted into the lock housing 20.

The actuator 40 can include a lock rod 44. The lock rod 44 can extend between a lever 36 (FIG. 5) on the inside surface 24 of the lock housing 20 and the dead bolt 42. More specifically, the lock rod 44 can be coupled to the lever 36 and to the cam 64. The cam 64 can rotate with the lock rod 44. The cam 64 can also be coupled to the dead bolt 42. Thus, as the lock rod 44 is rotated, the cam 64 is also rotated and drives the dead bolt 42 between an extended locked position and a retracted unlocked position.

The clutch 46 can be operably coupled to the lock rod 44. The clutch 46 can be selectively engaged in order to selectively turn the lock rod 44 and move the dead bolt 42. Similarly, the lever 36 can be manually turned in order to turn the lock rod 44 and move the dead bolt 42. In this way, the dead bolt 42 can be moved to the locked or unlocked position either manually with the lever 36 or automatically with the clutch 46.

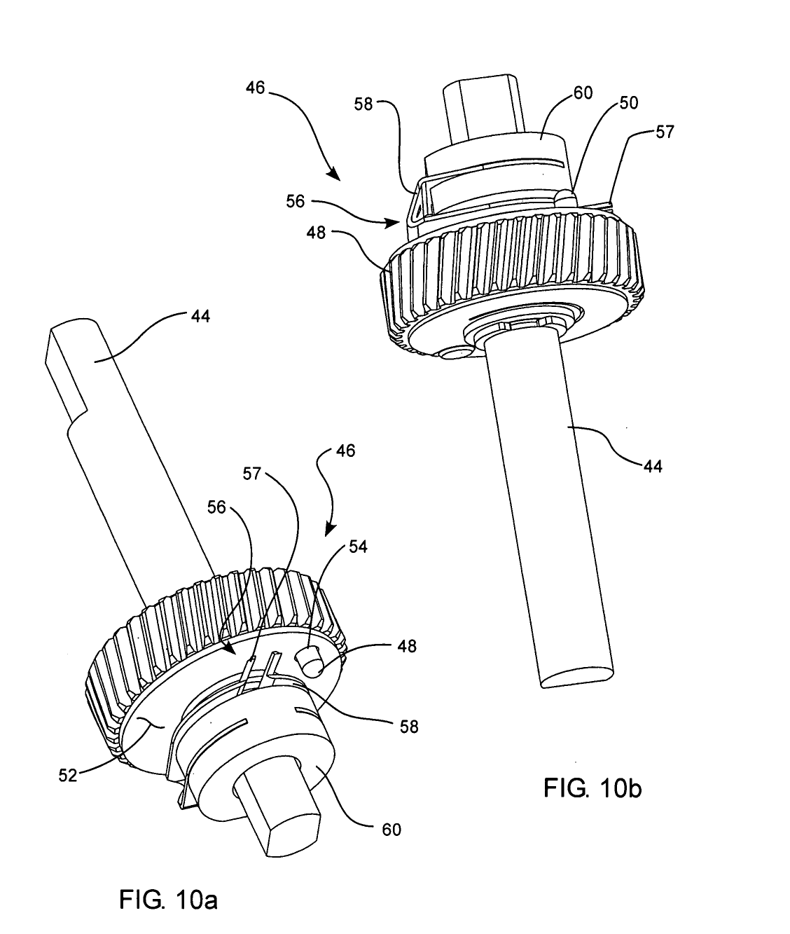

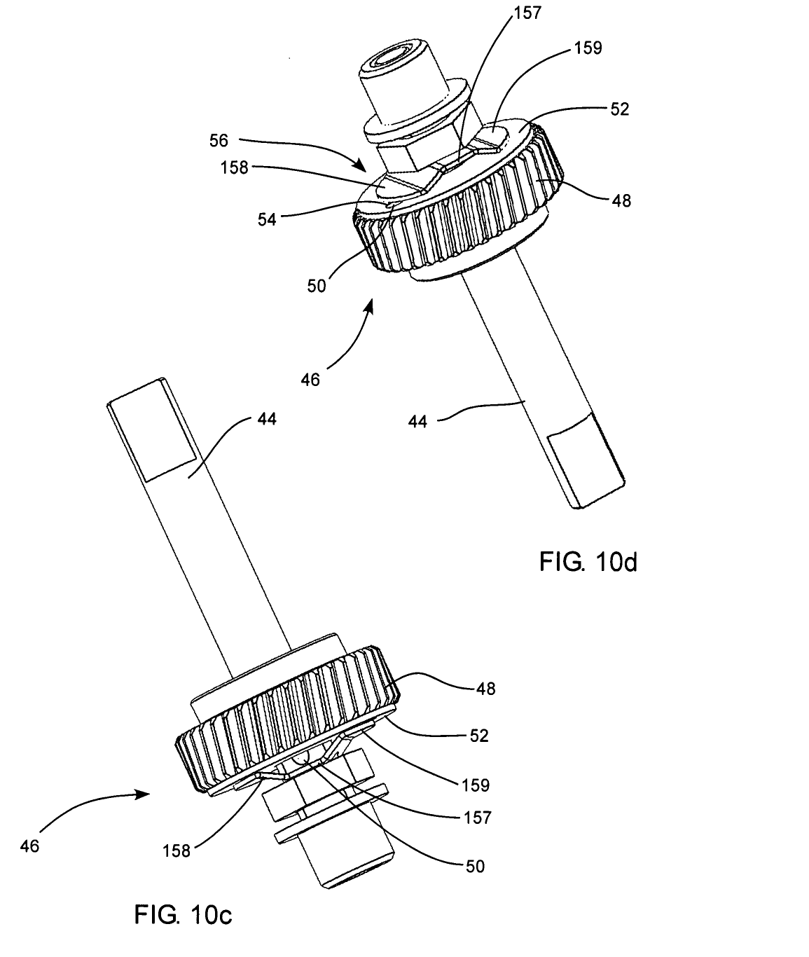

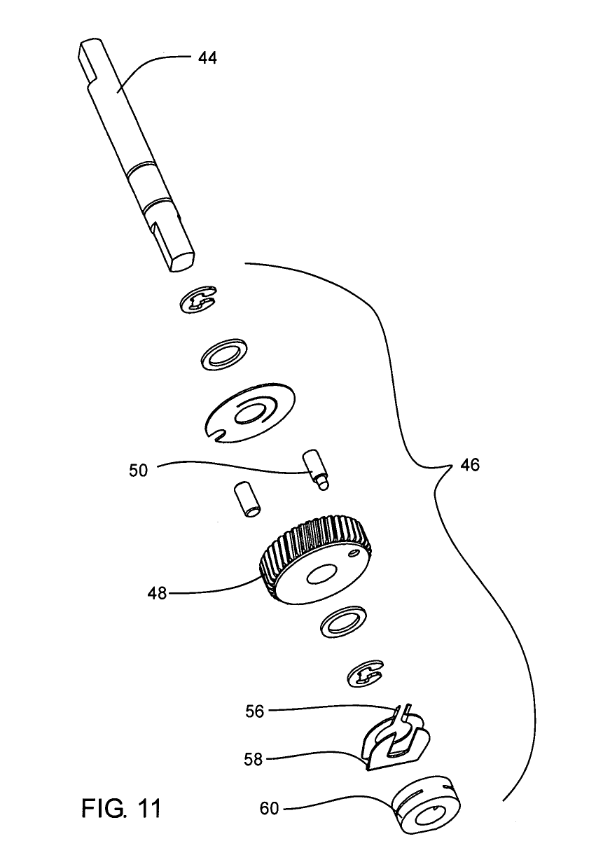

Turning to FIGS. 10a-11, the clutch 46 can include a screw gear 48 that can rotate about the lock rod 44. A spring loaded pin 50 can be associated with the screw gear 48. The spring loaded pin 50 can be movable between an extended position and a retracted position. The pin 50 can be pushed into the retracted position by a face 52 of the screw gear 48. The pin 50 can move to the extended position when a hole 54 in the face 52 of the screw gear 48 is aligned with the pin 50. The pin 50 can extend through the face 52 of the screw gear 48 and rotate with the screw gear when in the extended position.

A pin catch, indicated generally at 56, can be coupled to the lock rod 44. In one example, as shown in FIGS. 10a-10b, the pin catch 56 can be positioned adjacent the face 52 of the screw gear 48 so that as the screw gear rotates, the pin 50 can contact and rotate the pin catch 56 when the pin is in the extended position. The pin catch 56 can include to a pair of extensions 57 that can catch the pin when the pin is extended from the hole 54. The pin catch 56 can also include a spring clip 58 that can secure the pin catch to a mandrel 60 that can be secured to the lock rod 44. The mandrel 60 can be secured to the lock rod 44 by any suitable fastening means such as a set screw, welding, a keyway, or the like.

Additionally, as another example, as shown in FIGS. 10c-10d, the pin catch 56 can include a spring plate 158 that can have a face 159 that mounts adjacent to the face 52 of the screw gear 48, and a recessed portion 157 that extends away from the face 52 of the screw gear. In this case, the pin 50 can be pushed and held into the hole 54 in the screw gear 48 by the face 158, as shown in FIG. 10c. Additionally, the pin 50 can extend out of the hole 54 and be contained within the recessed portion 157 when the screw gear 48 is rotated to allow the pin to engage the spring plate. When in the extended position, the pin 50 can engage the recessed portion 157 to rotate the lock rod 44.

Because the pin catch 56 is coupled to the lock rod 44, the lock rod can rotate with the pin catch as the pin catch is rotated by the pin 50 when the pin is in the extended position. Thus, the lock rod 44 will rotate when the pin 50 is aligned with and extending through the hole 54 in the face 52 of the screw gear 48.

Similarly, the lock rod 44 will not rotate when the pin 50 is not extending through the hole 54. The pin 50 can be pushed back into the retracted position when a sufficiently high load is applied to the portion of the pin extending away from the face 52 of the screw gear 48 by the pin catch 56. Such a load can be applied to the pin by the pin catch when the handle 36 is manually turned. In this way, the screw gear 48 and spring pin 50 can act as the clutch 46 to selectively engage or disengage the lock rod 44.

The actuator 40 can also include an electrically powered driver, such as a motor 58 or a solenoid (not shown). In the case where the driver is a motor 58, the motor 58 can be disposed in the lock housing 20 and can be operably coupled to rotate a worm gear 62. The worm gear 62 can be positioned to engage and rotate the screw gear 48 when the motor 58 is activated. In this way, the motor 58 can be operated to move the dead bolt 42 between the locked and unlocked position.

In use, the motor 58 can be activated by the wireless receiver 70 when the wireless receiver 70 receives a signal from the wireless transmitter 80. When activated, the motor 58 can turn the worm gear 62 which in turn can engage and rotate the screw gear 48. The screw gear 48 can rotate until the pin 50 snaps through the hole 54 in the face 52 of the screw gear 48. The screw gear 48 and extended pin 50 can then rotate to engage and rotate the pin catch 56 which in turn rotates the lock rod 44.

The wireless receiver 70 can be coupled to the actuator 40 and can be configured to receive a wireless signal that can operate the actuator 40. The wireless receiver 70 can be any wireless reception device that can receive wireless signals such as an RF signal, an ultrasonic signal, an infrared signal, an ultraviolet signal, or the like. For example, the wireless receiver can be a radio receiver that can receive a radio frequency signal, an electronic eye that can receive an infrared signal, a sound detector that can receive an ultrasonic signal, and the like.

The wireless transmitter 80 can be any remote wireless transmission device that can transmit a signal to the wireless receiver in order to actuate the power lock 10. The wireless transmitter 80 can transmit a wireless signal such as an RF signal, an ultrasonic signal, an infrared signal, an ultraviolet signal, or the like. For example, the wireless transmitter 80 can be a key FOB 82, a handheld remote control, a cell phone, a garage door opener, a proximity card, a radio frequency identification (RFID) card or chip, proximity signal generator, a localized RF signal transmitter, or the like.

Thus, in use, the wireless transmitter 80 can be activated to transmit a wireless signal. The wireless receiver 70 can receive the signal and can activate the actuator 40. The actuator 40 can move the dead bolt 42 to the locked or unlocked position depending on the signal transmitted by the wireless transmitter. In this way, the power door lock 10 can be locked or unlocked from a position that is removed from the location of the walkthrough door 12.

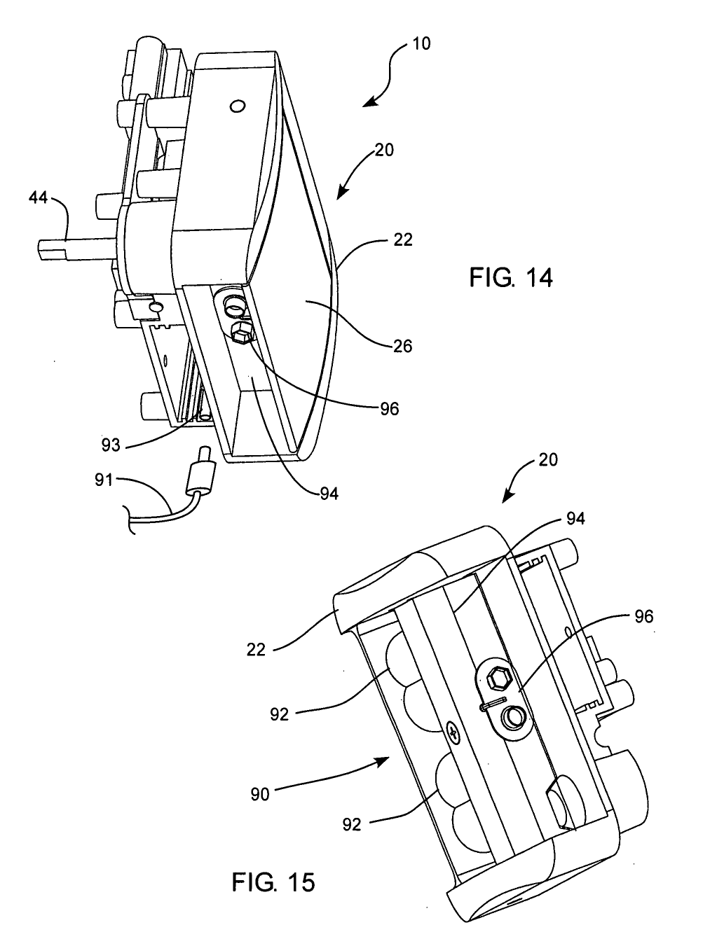

Referring to FIGS. 12-15, the power door lock 10 can also include a battery power source, indicated generally at 90, that can be electrically coupled to the wireless receiver 70 (FIG. 9) and the electrically powered driver of the actuator 46. In one embodiment, the battery power source 90 can be disposed in the lock housing 20 and positioned towards the outside of the door and substantially adjacent the outside handle 26, as shown in FIGS. 12 and 15. In another embodiment (not shown) the battery power source can be disposed in the lock housing and positioned towards the inside of the door and accessible from the inside of the RV. In yet another embodiment, the battery power source can be the battery power source for the RV and a hard wire 91 can extend from the RV battery power source to a hook up 93 in the power door lock 10 in the walkthrough door 12. In yet another embodiment, the power door lock 10 can be electrically coupled to both the RV battery power source and have an independent battery power source 90 inside the lock.

The battery power source 90 can have a plurality of battery bays 92 to house replaceable or rechargeable batteries. For example, the battery power source 90 can have 4 standard AA sized battery bays 92 to house batteries that can provide power to the power lock 10.

The battery power source 90 can also have a cover plate 94. The cover plate can be disposed adjacent the battery bays 92 and can close the battery bays to protect the batteries and close the battery circuit. The cover plate 94 can be positioned directly under or behind the outside handle 26.

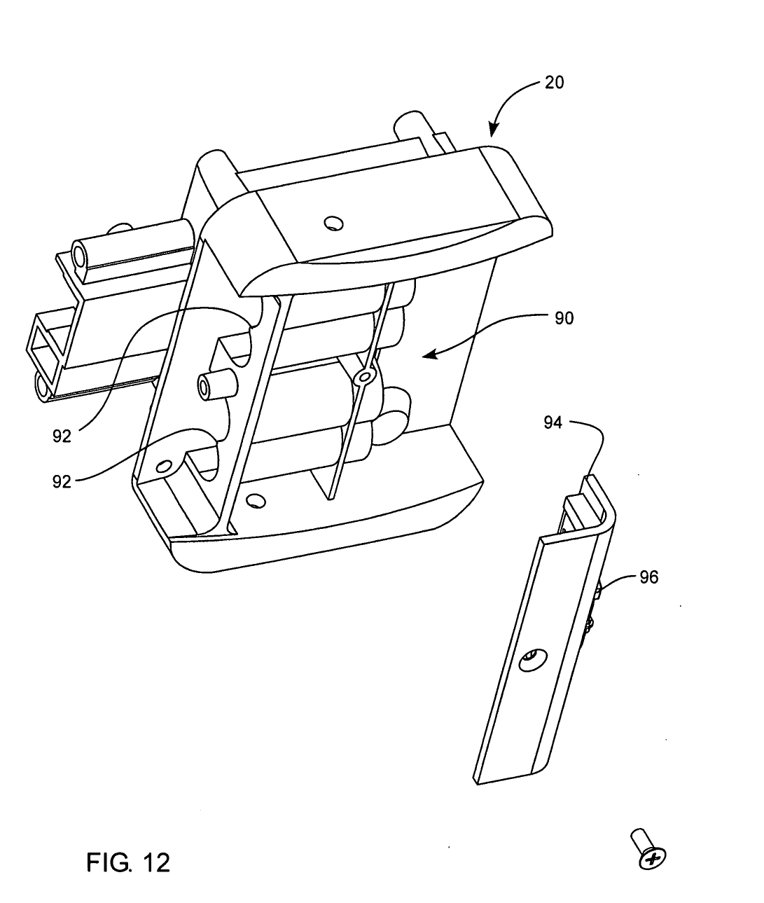

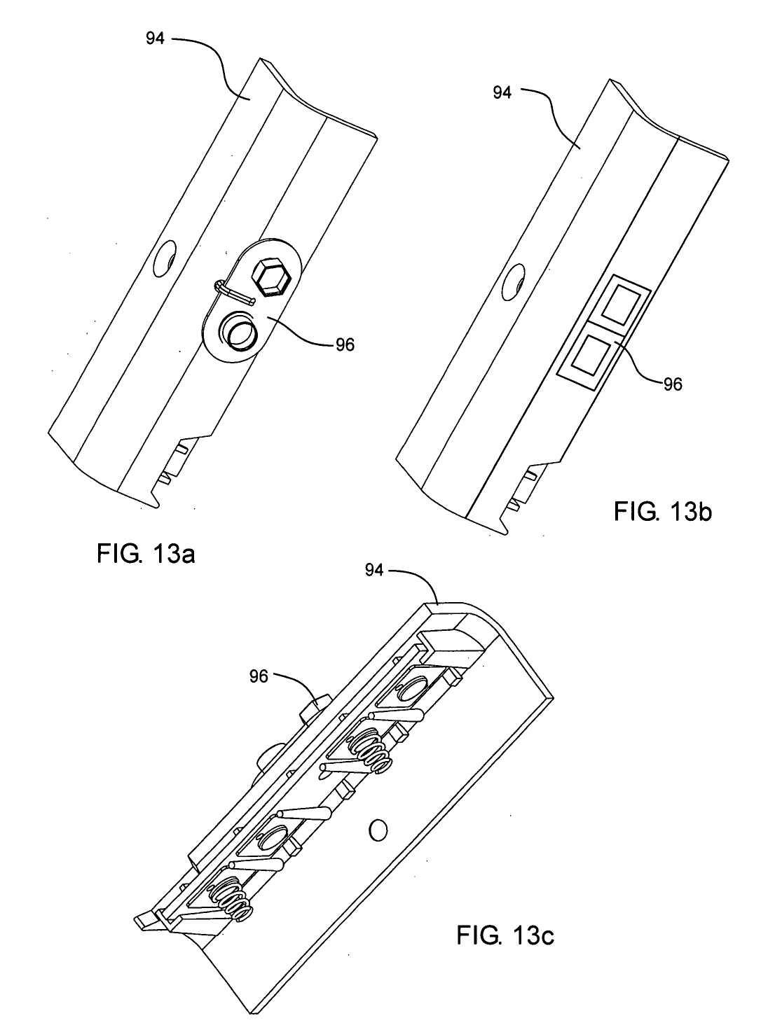

The cover plate 94 can also have an emergency battery hook up 96 that can be accessible under the outside handle 26, as illustrated in FIGS. 13a-13c. The emergency battery hook up 96 can allow connection to a battery outside the lock housing 20 to provide temporary emergency power to the power lock 10 in the event the batteries in the battery bays 92 run out of energy. For example, the emergency battery hook up 96 can be a standard 9 volt battery connection so that the user can place a 9 volt battery against the terminals 26 to provide temporary emergency power to the power lock 10 in the event the batteries inside the lock housing 20 have run out of energy and died. In another example, the emergency battery hook up can be a pair of relatively flat electrically conductive plates electrically coupled to the power driver and spaced apart on the cover plate so that battery prongs from a standard 9 volt battery can contact the conductive plates and provide power through the plates to the power lock 10.

The present invention also provides for a method for locking a walkthrough door of a Recreational Vehicle with a wireless remote controlled door lock. The method includes closing a walkthrough door on the RV. A wireless signal can be sent from a remote wireless transmitter to actuate a wireless remote door lock on the walk through door to lock the walkthrough door and restrict access to the RV. Additionally, the method includes sending a wireless signal from the remote transmitter to unlock the door lock on the walk through door. The walkthrough door can then be opened to allow access to the inside of the RV. Thus, the power lock of the present invention constitutes a new use of remotely activated power door locks, specifically, use of such locks in walkthrough doors of Recreational Vehicles.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A power door lock device for a walkthrough door of a Recreational Vehicle (RV), comprising:
a lock;
an actuator operably coupled to the lock and operable to engage the lock;
a wireless receiver coupled to the actuator and configured to receive a wireless signal to operate the actuator;
a remote wireless transmitter, configured to transmit a signal to the wireless receiver in order to actuate the lock.

2. The device of claim 1, wherein the lock includes a dead bolt and the actuator moves the dead bolt between a locked and an unlocked position.

3. The device of claim 1, wherein the actuator further includes:
a lock rod; and
a clutch, operably coupled to the lock rod to selectively engage the lock rod.

4. The device of claim 3, wherein the clutch further includes:
a screw gear, operably coupled to the lock rod and operable to rotate about the lock rod;
a spring loaded pin associated with the screw gear and movable between an extended position and a retracted position; and
a pin catch, coupled to the lock rod and positioned adjacent a face of the gear so that as the gear rotates, the pin contacts the pin catch and rotates the lock rod when the pin is in the extended position.

5. The device of claim 4, wherein the actuator includes a motor operably coupled to a worm gear positioned to engage the screw gear and operable by the wireless receiver upon receipt of a signal from the wireless transmitter to engage the screw gear and rotate the lock rod.

6. The device of claim 1, wherein the actuator is selected from the group consisting of an electric solenoid, an electric motor, and combinations thereof.

7. The device of claim 1, wherein the wireless transmitter and wireless receiver can transmit and receive wireless signals selected from the group consisting of an RF signal, an ultrasonic signal, an infrared signal, and an ultraviolet signal.

8. The device of claim 1, wherein the remote wireless transmitter is selected from the group consisting of a key FOB, a handheld remote control, a cell phone, a garage door opener, a proximity card, a RFID card, a RFID proximity chip, localized RF signal transmitter, and proximity signal generator.

9. The device of claim 1, wherein the automatic door locking device is a discreet modular unit configured to fit within an existing lock opening in a walkthrough door of a recreational vehicle without alteration of the walkthrough door.

10. The device of claim 1, further including a battery power source electrically coupled to the wireless receiver and the actuator.

11. The device of claim 10, further comprising an emergency battery hook up associated with the battery power source and accessible from an outside plate of the power lock, the emergency battery hook up being configured to couple to an independent power source to provide power to the power lock in the event the internal battery power source is dead.

12. A recreational vehicle, comprising
a shell having at least one walkthrough door;
a door lock, coupled to the at least one walk through door, and configured to lock the at least one walk through door to the shell, the door lock further comprising:
a lock;
an actuator operably coupled to the lock and operable to engage the lock;
a wireless receiver coupled to the actuator and configured to receive a wireless signal to operate the actuator;
a remote wireless transmitter, configured to transmit a signal to the wireless receiver in order to actuate the lock.

13. The recreational vehicle of claim 10, wherein the recreational vehicle is selected from the group consisting of a travel trailer, a camp trailer, a motor home, a tent trailer, a fifth wheel trailer, and a bus.

14. A method for locking a walk through door of a recreational vehicle with a wireless remote controlled door lock, comprising:
closing a walk through door on the recreational vehicle; and
sending a wireless signal from a remote transmitter to actuate a wireless remote door lock on the walk through door to lock the walk through door and restrict access to the recreational vehicle.

15. The method of claim 12, further comprising:
sending a wireless signal from the remote transmitter to unlock the door lock on the walk through door; and
opening the walk through door to allow access to the recreational vehicle.
